(19) United States
(12) Patent Application Publication
(10) Pub. No.: US 2011/0015922 A1
(43) Pub. Date: Jan. 20, 2011

(54) Speech Intelligibility Improvement Method and Apparatus

(76) Inventor: Larry Joseph Kirn, Austin, TX (US)

Correspondence Address: GIFFORD, KRASS, SPRINKLE,ANDERSON & CITKOWSKI, P.C, PO BOX 7021, TROY, MI, 48007-7021, US

(21) Appl. No.: 12/839,720

(22) Filed: Jul. 20, 2010

Related U.S. Application Data
(60) Provisional application No. 61/226,786, filed on Jul. 20, 2009.

(51) Int. Cl. G10L 21/00; G10L 19/02

(52) U.S. Cl. 704/203; 704/206; 704/E21.009

(57) ABSTRACT

Prevalence detection is advantageously applied to the result of specific spectral discrimination to adaptively determine prevalent frequencies existing within an audio signal containing speech. Prevalent frequencies in this audio signal so isolated are attenuated in a highly selective manner, thus reducing the masking potential of pervasive resonances and obfuscative energy within the speech itself over low energy language-imparting speech elements.

### REFERENCE TO RELATED APPLLICATION

This application claims priority from U.S. Provisional Patent Application Ser. No. 61/226,786 filed Jul. 20, 2009, the entire content of which is incorporated herein by reference.

### FIELD OF THE INVENTION

This invention relates generally to audio signal processing, and particularly to methods and apparatus to improve intelligibility of signals originating as human speech.

### BACKGROUND OF THE INVENTION

Ability to understand speech is a critical issue, particularly in the presence of high ambient noise, low transmission bandwidth, or hearing deficit. Almost all research in improving speech intelligibility to date has focused on mitigating deleterious effects of external sound sources—competitive noises along the path between speaker and listener. Mitigation directed at competitive noise often uses relatively broad spectral widths, in that characterization of these noise sources is often tenuously known,. The repetitive nature of many noise sources has also encouraged longer time frames for any dynamic reduction behavior. Improvement of speech intelligibility through external noise reduction therefore almost always operates on wide spectral ranges with relatively slow dynamic behavior.

Early speech research met severe technical limitations, notably the filters available to early hearing research had limited frequency discrimination. This limitation, in conjunction with limited ability of technologies in use to quickly discern specific spectral features in real time, enforced the use of relatively static filtering with broad bandwidths. This practice became codified into mainstream research as the tuning bands universally seen in the field. Adoption of accepted broad spectral bands as common practice, however, has diminished visibility of the fact that the masking capacity of competitive sound often is in inverse proportion to bandwidth. This could be seen as intuitive, considering energy density differential between a single frequency and broader-bandwidth noise, yet highly-specific spectral manipulation is not commonly seen in speech applications.

Speech as it is commonly heard contains a preponderance of energy that imparts information about the speaker's identity, condition, environment, etc., yet conveys no language information. The energy integrals of specific speech elements are as well coming to be seen as disproportionate with the language information they impart Most speakers are then found to emit several highly specific individuated spectral components which do not aid speech intelligibility in any way. Nasal resonance, as a notable example, is pervasive yet carries no language.

It has been recognized for some time that both temporal and spectral proximity of competitive sound sources increase their potential to hide or mask perception of desired sound or speech. Head resonances, which are pervasive and often occur at frequencies very near those of critical speech elements, therefore constitute potential masking sources for other speech elements. Some vowels, characterized by much higher energy integrals than critical low-energy short-duration speech elements at nearby frequencies, can also be seen as potential masking agents for some consonants. These and other non-language components of speech can be seen to impact reception of more fragile speech elements, with lower energy integrals. Many consonants, typically at higher frequencies and shorter durations, fall into this disadvantaged category; yet serve to impart much more language information than the speech energy potentially masking them. These critical elements may then be effectively masked by other components of the speech itself, even before competition from external sources takes a toll on intelligibility.

Although static passband filtering to accentuate typical frequency bands necessary for speech is in common practice, very little work has been done to isolate and mitigate these internal elements within speech itself which may degrade intelligibility. Being internal to the speaker, these potential masking sources are not deterred by noise reduction techniques which target noise sources external to both the speaker and listener. Although pronounced, head resonances and strong vowels are highly individuated from speaker to speaker, highly unpredictable, and highly frequency-specific; so are not easily addressed by invariant wide-bandwidth filtering commonly used. Even with the capacity to selectively remove these components in an agile fashion, an adaptive targeting method is necessary to address the mercurial nature of the masking sources

Especially in situations of hearing deficit or high ambient noise, a need exists for a method whereby perceived speech intelligibility is improved through identification and reduction of internal speech elements with disproportionately high energy to informational contribution.

### SUMMARY OF THE INVENTION

The present invention resides in the apparatus and technique to improve speech intelligibility through adaptive identification and selective attenuation of specific frequencies found to be statistically prevalent in an audio stream.

A method for improving speech intelligibility comprising the steps of:
1. Detecting specific frequency components of an audio stream with statistically significant prevalence over a deterministic period of time.
2. Selectively attenuating those specific frequency components without degradation of surrounding spectral components.

### BRIEF DESCRIPTION OF THE DRAWINGS

FIG. 1 shows a block diagram of an exemplary embodiment of the present invention.

FIG. 2 shows a block diagram of an alternative exemplary embodiment of the present invention.

### DETAILED DESCRIPTION OF THE INVENTION

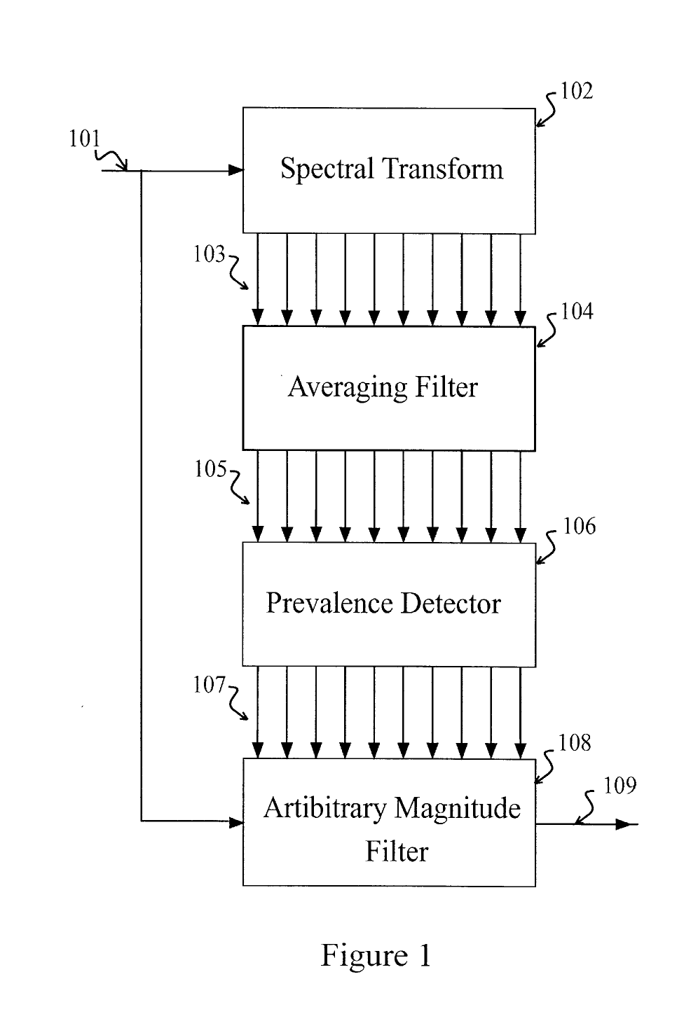

Referring now to FIG. 1, Signal Source 101 provides incoming audio signal to both Spectral Transform 102 and Arbitrary Magnitude Filter 108. Spectral Transform 102 converts time-domain signal 101 into individuated frequency-domain spectral components 103.

Said individuated spectral components 103 are applied as input to Averaging Filter 104, which calculates individual long-term averages for each spectral component input. The averaged spectral components 105 thus obtained are input to Prevalence Detector 106.

Said Prevalence Detector 106 calculates prevalence of each spectral component, preferentially relative to the average of all incoming spectral components, and outputs individual prevalence signals 107 for each incoming averaged spectral component 105. Prevalent incoming averaged spectral components result in outputs proportional to their individual prevalence; non-prevalent incoming averaged spectral components result in null outputs. The spectral component average prevalence outputs 107 thus calculated are supplied to Arbitrary Magnitude Filter 108 as spectral component attenuation inputs.

Although shown as a simple functions, use of frequency, amplitude, and time dependencies, as well as non-linear operation are anticipated for Averaging Filter 104 and Prevalence Detector 106.

Arbitrary Magnitude Filter 108 attenuates each individual spectral component of incoming time-domain voltage 101 in proportion to its spectral component attenuation input 107. The filtered form of incoming signal 101 is then output as Output Signal 109.

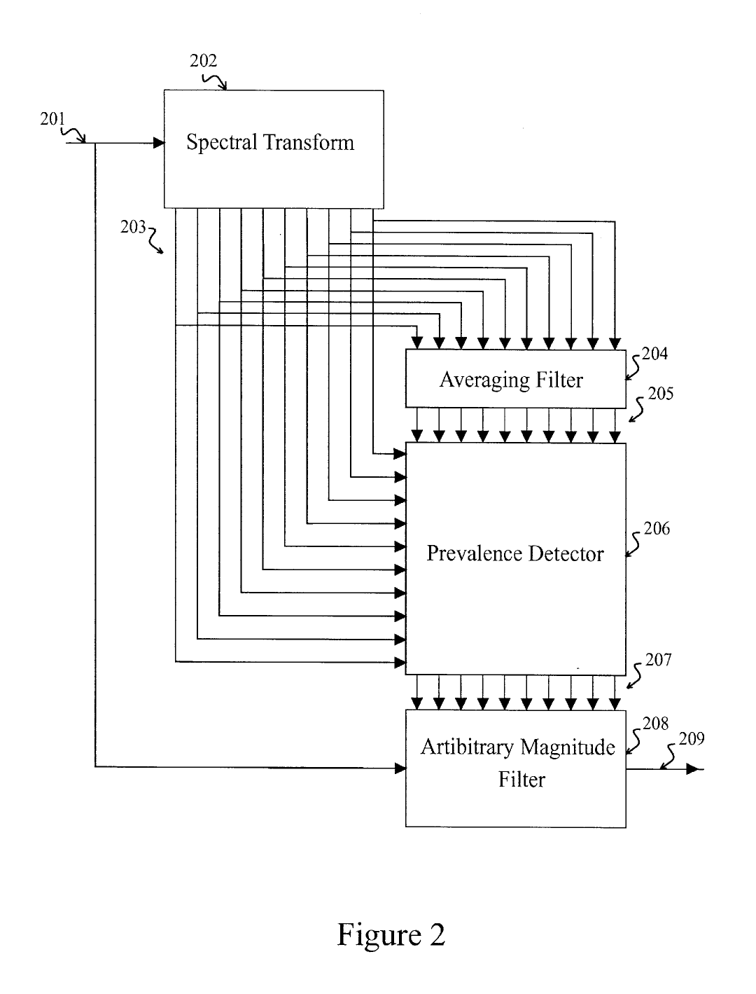

Referring now to FIG. 2, Signal Source 201 provides incoming audio signal to both Spectral Transform 202 and Arbitrary Magnitude Filter 208. Spectral Transform 202 converts time-domain signal 201 into individuated frequency-domain spectral components 203.

Said individuated spectral components 203 are applied as input to both Averaging Filter 104 and Prevalence Detector 206. The averaged spectral components 205 obtained from Averaging Filter 204 are as well provided as input to Prevalence Detector 206. Note that the addition of non-historical spectral components 203 as input to Prevalence Detector 206 serves solely to improve transient response, particularly at cessation of specific individuated spectral components 203.

Said Prevalence Detector 206 calculates prevalence of each spectral component 203, preferentially relative to the average of all incoming spectral components and within the context of filtered spectral components 205, providing prevalence signals 207 for each incoming spectral component 203. As shown in FIG. 1, prevalent incoming averaged spectral components result in outputs proportional to their individual prevalence; non-prevalent incoming averaged spectral components result in null outputs. The spectral component average prevalence outputs 207 thus calculated are supplied to Arbitrary Magnitude Filter 208 as spectral component attenuation inputs.

Arbitrary Magnitude Filter 208 attenuates each individual spectral component of incoming time-domain voltage 201 in proportion to its spectral component attenuation input 207. The filtered form of incoming signal 201 is then output as Output Signal 209.

In that FIGS. 1 and 2 are functionally equivalent, FIG. 1 is now used for explanation. In use, an input signal containing speech is separated by frequency by Spectral Transform 102 into as many components as is practical in a given implementation. This use of highly specific spectral components is a departure from the majority of prior art, which relies upon a small number of wide frequency categories. Use of highly specific spectral determination allows the invention to accurately locate speaker-specific resonances, with a high degree of selectivity between speakers or between a speaker and ambient noise. Historical context of spectral components 105, from Filter 104, is used to determine prevalence of individual frequencies within a time frame determined by the time constants of Filter 104. Note that the dynamic nature of speech may necessitate use herein of shorter filter time constants than those commonly associated with noise reduction techniques. Weighting of individual spectral components as a function of hearing sensitivity, energy integration for each spectral component, and weighting by iteration within a given time frame for each spectral component are among the approaches known to the art which are anticipated for use in prevalence detection, being distinct from prior averaging techniques. Outputs of Prevalence Detector 106 may therefore exhibit non-linearities in characteristics such as amplitude, frequency, and/or time as a result; to provide outputs indicative of notably aural prevalence of specific frequencies within the input to the invention. Use of these frequency-specific prevalence indicators as attenuation inputs of an arbitrary filter facilitates selective removal of these frequencies when applied to the incoming audio stream. In keeping with the operating principles described herein, it is assumed that the arbitrary filter used possesses frequency selectivity at least commensurate with that of the transform used for detection. This selectivity is necessary to allow removal of objectionably frequencies without destruction of surrounding audio content.

As can be seen by the detailed description above, prevalent frequency components of an audio stream are effectively located and selectively attenuated, thus preventing them from impairing intelligibility. It can as well be seen that spectral features which occur less frequently will pass undeterred. Pervasive resonances in any given speaker will therefore be prevented from masking lower-energy speech components.

I claim:

1. A system for improving intelligibility of speech comprising:
means to receive a signal containing audio information;
means to determine relative amplitudes or energies of specific frequencies within at least a spectral subset of said signal;
means to retain history of said relative amplitudes of specific frequencies;
means to adaptively determine prevalence of specific frequencies within said signal; and
means to selectively attenuate specific frequencies found to be prevalent within said signal.

2. The system of claim 1 wherein said means to adaptively determine relative amplitudes of specific frequencies comprises a chirp or wavelet transform.

3. The system of claim 1 wherein said history of said relative amplitudes or energies of specific frequencies comprises an averaging filter.

4. The system of claim 1 wherein said means to adaptively determine prevalence of specific frequencies is weighted by frequency to approximate an average human hearing frequency response.

5. The system of claim 1 wherein said means to adaptively determine prevalence of specific frequencies incorporates frequency-specific energy integration.

6. The system of claim 1 wherein said means to selectively attenuate specific frequencies comprises a convolution.

7. The system of claim 1 wherein at least a portion of the system is embodied as software executing on a processing unit.

8. A method of improving intelligibility of speech comprising the steps of:
receiving a signal containing audio information;
determining relative amplitude or energy of specific frequencies within at least a portion of the spectrum received;
determining the prevalence of specific frequencies within at at least a portion of the spectrum received during a deterministic time frame; and
selectively attenuating only those specific frequencies found to be prevalent within said signal.

9. The method of claim 8 whereby prevalence of specific frequencies is determined using statistical techniques.

10. The method of claim 8 whereby frequency, amplitude, or temporal response is non-linear with any variable.
